(19) United States
(12) Patent Application Publication
(10) Pub. No.: US 2026/0132093 A1
(43) Pub. Date: May 14, 2026

(54) LIQUID FERTILIZERS COMPRISING POTASSIUM AND POTASSIUM SOLUBILIZING MICROORGANISMS

(71) Applicant: Tessenderlo Group NV, Brussels (BE)

(72) Inventors: Robab Ghahramanzadeh, Brussels (BE); Nicolas White, Loos (FR)

(73) Assignee: Tessenderlo Group NV, Brussels (BE)

(21) Appl. No.: 18/696,374

(22) PCT Filed: Sep. 30, 2022
(86) PCT No.: PCT/EP2022/077306

§ 371 Date: Mar. 28, 2024

(30) Foreign Application Priority Data
Oct. 1, 2021 (EP) 21200480.8

(51) Int. Cl. C05F 11/08; C05D 1/02; C05D 1/04; C05G 5/23

(52) U.S. Cl. CPC C05F 11/08; C05D 1/02; C05D 1/04; C05G 5/23

(57) ABSTRACT

The present invention relates to liquid fertilizers comprising a first source of potassium in an amount providing 0.01-5 wt. % (by total weight of the fertilizer) potassium (as K₂O) and potassium solubilizing microorganisms. It also relates to methods of manufacturing these fertilizers and to uses of these fertilizers for providing nutrients to plants.

### FIELD OF THE INVENTION

The present invention relates to liquid fertilizers comprising potassium and potassium solubilizing microorganisms. It also relates to methods of manufacturing these fertilizers and to uses of these fertilizers for providing nutrients to plants.

### BACKGROUND OF THE INVENTION

After nitrogen and phosphorus, potassium is one of the major nutrients required by all the plants. It plays a major role in the activation of several metabolic processes including protein synthesis, photosynthesis, enzyme activation, the transport of water and nutrients in the plants through xylem and synthesis of starch. It also plays a role in improving quality and shelf life of crops as well as resistance to stress and disease. It is often observed that without adequate potassium, the plants have poorly developed roots, grow slowly, produce small seeds and have lower yields.

Potassium in soil exists in different forms but the crop can absorb what is present in soil solution only. The readily available potassium in soil solution is just 2% out of the total, and the remaining part of soil potassium is locked up in soil minerals and hence most of it is unavailable for plant uptake. Also, in most of the soils, potassium levels decrease easily due to crop uptake, runoff, leaching and soil erosion.

Soil potassium management strategies primarily rely on the application of potassium fertilizers. A diverse group of potassium fertilizers exist, with notable examples being potassium thiosulfate and potassium sulfate which are available under brand names KTS®, GranuPotasse®, SoluPotasse®, K-Leaf® from Tessenderlo Kerley. Some potassium fertilizers are suitable for fertigation or foliar application, for example KTS® (which is a liquid) and SoluPotasse® and K-Leaf® (which are highly soluble forms of potassium sulfate, allowing dissolution for e.g. fertigation or spray application).

In recent years, soil potassium management strategies relying on the application of potassium solubilizing bacteria and other microorganisms (also interchangeably referred to as potassium mobilizing micro-organisms) as biofertilizer instead of direct application of potassium have emerged. A large number of saprophytic bacterial and fungal strains have been identified which solubilize potassium from insoluble forms like mica, fledspar and others by microbial production of protons and organic ligands, hydroxyl anions and extracellular polysaccharides (EPS), which can either directly dissolve rock potassium or chelate silicon ions to bring potassium into the solution.

Ali, A., et al. Archives of Agriculture Sciences Journal 2.2 (2019): 43-54 describes treatment of a plot of potato tubers with NPK fertilization in the form of superphosphate (applied during land preparation), urea (applied 30, 60 and 90 days after planting) and a mixture of feldspar, filter mud cake and potassium sulfate (applied 30, 60 and 90 days after planting). Potassium solubilizing bacteria Bacillus cereus was added after emergence of potato plants and once again after one week.

A disadvantage of known soil potassium management strategies employing potassium solubilizing microorganisms is that they rely on either (i) application of only the potassium solubilizing microorganism without applying a potassium fertilizer throughout the growing season, which limits use of this strategy to high potassium content soils and still results in very limited potassium availability for the crop (and thus low crop health benefits or yield increase); or (ii) separate applications of the potassium solubilizing microorganism and potassium fertilizer, leading to a complex application scheme requiring more interventions than a conventional NPK fertilization scheme, which is very labor intensive and thus costly.

It is an object of the present invention to provide products and methods which simplify and/or improve existing crop potassium management strategies, crop health, crop yield, etc.

### SUMMARY OF THE INVENTION

The present inventors have surprisingly found that one or more objects of the invention is achieved by employing a liquid fertilizer which includes potassium solubilizing microorganisms, as described herein. Indeed, as is shown in the appended examples, it was found that it is possible for potassium solubilizing microorganisms to survive in the chemical environment provided by liquid potassium fertilizers. This enables a convenient, shelf-life stable fertilizer to be provided and results in a surprising increase in crop health and performance characteristics, in particular yield and quality. The formulations described herein are particularly practical to use since they allow the fertilizer and the microorganisms to be applied simultaneously, as opposed to the known separate application modes which are more labor intensive. The fertilizers of the present invention are ready-to-use, for example by fertigation or foliar spray. The fertilizers of the present invention also easily allow an even distribution of the potassium solubilizing microorganism over the whole application area to be achieved, which is difficult when applying potassium solubilizing microorganism alone because the required dose and thus amount of inoculum to be applied is very small. By using the potassium source as a carrier, the potassium solubilizing microorganism can be more accurately and evenly dosed. Without wishing to be bound by any theory, it is believed that the formulations of the present invention further synergistically improve performance over separate application of potassium solubilizing microorganisms and potassium fertilizers since they guarantee that the microorganism will be in close contact with potassium-bearing compounds, independent of potassium content of soils and distribution of that potassium content over different soil layers (e.g. microorganisms applied to the top soil do not easily access potassium formations in lower layers), and the close contact of the potassium solubilizing microorganisms and potassium fertilizers is believed to decrease the K-fixation rate of the applied potassium fertilizer (effectively slowing down conversion of the fertilizer to unavailable forms of potassium).

In a first aspect of the present invention there is provided a fertilizer comprising
(i) a first source of potassium in an amount providing 0.01-5 wt. % (by total weight of the fertilizer) potassium (as K₂O), preferably 0.05-5 wt. %;
(ii) a potassium solubilizing microorganism; and
(iii) water.

In another aspect, the present invention provides a method for the preparation of a fertilizer as described herein comprising the steps of:
a) providing a first source of potassium as described herein;
b) providing a potassium solubilizing microorganism as described herein; and
c) combining the first source of potassium of step (i) and the potassium solubilizing microorganism of step (ii) with water.

In another aspect, the present invention provides the use of the fertilizers of the invention:
as fertilizer; and/or
for providing nutrients to plants; and/or
for improving the morphological characteristics, the physiological characteristics and/or the yield of tomato crop, preferably for improving the morphological characteristics, the physiological characteristics and/or the yield of tomato crop compared to an identical fertilization scheme wherein no microorganism is applied; and/or
for increasing the starch content, the yield, and/or the average tuber size of potato crop, preferably for increasing the starch content, the yield, and/or the average tuber size of potato crop compared to an identical fertilization scheme wherein no microorganism is applied; and/or
for increasing the leaf K content, preferably for increasing the leaf K content compared to an identical fertilization scheme wherein no microorganism is applied; and/or
for improving the vitamin C content and/or the lycopene content of a crop, preferably a tomato crop.

In another aspect, the present invention provides a kit-of-parts comprising a first source of potassium as described herein; a potassium solubilizing microorganism as described herein; and instructions for combining the first source of potassium and the potassium solubilizing microorganism with water such that a fertilizer as described herein is obtained.

### DETAILED DESCRIPTION

The expression “comprise” and variations thereof, such as, “comprises” and “comprising” as used herein should be construed in an open, inclusive sense, meaning that the embodiment described includes the recited features, but that it does not exclude the presence of other features, as long as they do not render the embodiment unworkable.

The expressions “one embodiment”, “a particular embodiment”, “an embodiment” etc. as used herein should be construed to mean that a particular feature, structure or characteristic described in connection with the embodiment is included in at least one embodiment. Thus, the appearances of such expressions in various places throughout this specification do not necessarily all refer to the same embodiment. Furthermore, the particular features, structures, or characteristics may be combined in any suitable manner in one or more embodiments. For example, certain features of the disclosure which are described herein in the context of separate embodiments are also explicitly envisaged in combination in a single embodiment.

The singular forms “a,” “an,” and “the” as used herein should be construed to include plural referents unless the content clearly dictates otherwise. It should also be noted that the term “or” is generally employed in its broadest sense, that is as meaning “and/or” unless the content clearly dictates otherwise.

The expression “potassium (as K₂O)” when used in relation to the potassium content is known to the skilled person and should be construed to mean the potassium content as expressed in terms of the amount of K₂O which would provide the same amount of potassium as provided by whichever potassium source is actually contained in the fertilizer. For example, if the first source of potassium is potassium sulfate (which comprises 44.88 wt. % potassium) and the fertilizer comprises 5 gram potassium sulfate per 100 g of fertilizer, then the fertilizer comprises the first source of potassium in an amount providing 2.24 wt. % potassium (by total weight of the fertilizer), which is typically expressed in the art and throughout this document as 2.69 wt. % (by total weight of the fertilizer) potassium (as K₂O). The wt. % potassium can be converted to the wt. % potassium (as K₂O) by multiplication with the factor 1.2.

The expression “liquid” as used herein should be construed to encompass slurries and pastes, unless otherwise specified.

In a first aspect of the present invention there is provided a fertilizer comprising
(i) a first source of potassium in an amount providing 0.01-5 wt. % (by total weight of the fertilizer) potassium (as K₂O), preferably 0.05-5 wt. % (by total weight of the fertilizer) potassium (as K₂O);
(ii) a potassium solubilizing microorganism; and
(iii) water.

In preferred embodiments of the invention, the first source of potassium is selected from the group consisting of potassium sulfate (K₂SO₄), potassium bisulfate (KHSO₄), potassium thiosulfate (K₂S₂O₃), dipotassium sulfite (K₂SO₃) potassium bisulfite (KHSO₃), potassium chloride (KCl), potassium magnesium sulfate (K₂SO₄·2MgSO₄), potassium nitrate (KNO₃), potassium sodium nitrate KNa(NO₃)₂, potassium hydroxide (KOH), potassium carbonate (K₂CO₃KHCO₃), potassium orthophosphate KH₂PO₄K₂HPO₄, potassium polyphosphate (K₄P₂O₇), potassium metaphosphate (KPO₃), polyhalite (K₂Ca₂Mg(SO₄)₄·2H₂O), langbeinite (K₂Mg₂(SO₄)₃), kainite (KMg(SO₄)·Cl·3H₂O), picromerite (K₂SO₄·MgSO₄·6H₂O), leonite (K₂SO₄·MgSO₄·4H₂O), aphthitalite (K₃Na(SO₄)₂), K-feldspar minerals (e.g. orthoclase, microcline, sanidine, adularia, and/or amazonite), feldspathoid minerals (e.g. nepheline, leucite), K-bearing phyllosilicates (e.g. illite) and combinations thereof. More preferably the first source of potassium is selected from the group consisting of potassium sulfate (K₂SO₄), potassium bisulfate (KHSO₄), potassium thiosulfate (K₂S₂O₃), dipotassium sulfite (K₂SO₃) potassium bisulfite (KHSO₃), potassium magnesium sulfate (K₂SO₄·2MgSO₄), polyhalite (K₂Ca₂Mg(SO₄)₄·2H₂O), langbeinite (K₂Mg₂(SO₄)₃), K-feldspar minerals (e.g. orthoclase, microcline, sanidine, adularia, and/or amazonite), feldspathoid minerals (e.g. nepheline, leucite), K-bearing phyllosilicates (e.g. illite) and combinations thereof. Still more preferably the first source of potassium is selected from the group consisting of potassium sulfate (K₂SO₄), potassium bisulfate (KHSO₄), potassium thiosulfate (K₂S₂O₃), potassium magnesium sulfate (K₂SO₄·2MgSO₄), polyhalite (K₂Ca₂Mg(SO₄)₄·2H₂O), langbeinite (K₂Mg₂(SO₄)₃) and combinations thereof. Most preferably the first source of potassium is potassium sulfate (K₂SO₄).

It is also preferred that the fertilizer of the invention comprises less than 2 wt. % (by total weight of the fertilizer), preferably less than 0.5 wt. %, more preferably less than 0.1 wt. % of carboxylic acid salts of potassium. In some embodiments of the invention, the fertilizer is substantially free of carboxylic acid salts of potassium.

In preferred embodiments of the invention, the first source of potassium is preferably provided in an amount providing 0.1-5 wt. % (by total weight of the fertilizer) potassium (as K₂O), preferably 0.1-4 wt. %.

In preferred embodiments of the invention, the total amount of potassium (as K₂O) in the fertilizer is less than 15 wt. % (by total weight of the fertilizer), preferably less than 8 wt. %, more preferably less than 5%.

In some embodiments of the invention, the fertilizer comprises one or more further sources of potassium next to the first source of potassium. In case the fertilizer comprises one or more further sources of potassium (e.g. from organic sources such as compost or manure), it is preferred that such other sources of potassium are comprised in the fertilizer in an amount providing less than 1 wt. % (by total weight of the fertilizer) potassium (as K₂O), preferably less than 0.5 wt. %, more preferably less than 0.1 wt. %.

In preferred embodiments of the invention, the amount of chloride (Cl⁻) in the fertilizer is less than 5 wt. % (by total weight of the fertilizer), more preferably less than 3 wt. %.

In preferred embodiments of the invention, the amount of sulfite (SO₃⁻) in the fertilizer is less than 3 wt. % (by total weight of the fertilizer), more preferably less than 1 wt. %.

In an embodiment of the invention, the potassium solubilizing microorganism is selected from microorganisms which display a halo zone after 72 hours when tested in accordance with the protocol defined in Rajawat, Mahendra Vikram Singh, et al. “A modified plate assay for rapid screening of potassium-solubilizing bacteria.” Pedosphere 26.5 (2016): 768-773 (which reference is incorporated herein in its entirety), employing the modified Aleksandrov medium with BTB at 100 mg/l. In preferred embodiments of the invention, the potassium solubilizing microorganism is in the form of spores or cysts.

In preferred embodiments of the invention the potassium solubilizing microorganism is selected from the genera Achromobacter, Acidithiobacillus, Alcaligenes, Agrobacterium, Aminobacter, Arthrobacter, Aspergillus, Azospirillum, Azotobacter, Bacillus, Bradyrhizobium, Brevibacillus, Brevundimonas, Burkholderia, Buttiauxella, Chryseobacterium, Citrobacter, Cladosporium, Clostridium, Colletotrichum, Delftia, Enterobacter, Ensifer, Erwinia, Escherichia, Exiguobacterium, Glomus, Frateuria, Flavobacterium, Flectobacillus, Fusarium, Janthinobacterium, Klebsiella, Kluyvera, Kocuria, Lactobacillus, Leclercia, Macrophomina, Mesorhizobium, Methylobacterium, Microbacterium, Myroides, Paenibacillus, Pantoea, Penicillium, Pseudomonas, Pusillimonas, Rahnella, Ralstonia, Rhizobium, Rhizoctonia, Salmonella, Sclerotinia, Schizophyllum, Serratia, Sphingobacterium, Sphingomonas, Stenotrophomonas, Staphylococcus, Thiobacillus, Trichoderma, and combinations thereof, preferably the potassium solubilizing microorganism is selected from the genera Bacillus, Frauteria, Pseudomonas, and combinations thereof, more preferably the potassium solubilizing microorganism is selected from the genera Bacillus and/or Pseudomonas. Suitable species of microorganisms within these genera are known to the skilled person and are for example listed on pages 181-185 of Kour, Divjot, et al. “Potassium solubilizing and mobilizing microbes: biodiversity, mechanisms of solubilization, and biotechnological implication for alleviations of abiotic stress.” New and Future Developments in Microbial Biotechnology and Bioengineering. Elsevier, 2020. 177-202, incorporated herein by reference.

In preferred embodiments of the invention the potassium solubilizing microorganism is one or more species selected from the group consisting of Achromobacter piechaudii, Acidithiobacillus ferrooxidans, Acidithiobacillus ferrooxidans, Acidithiobacillus thiooxidans, Agrobacterium radiobacter, Agrobacterium rubi, Agrobacterium tumefaciens, Alcaligenes piechaudii, Aspergillus awamori, Aspergillus candidus, Aspergillus flavus, Aspergillus fumigatus, Aspergillus glabrum, Aspergillus niger, Aspergillus terreus, Aspergillus wentii, Azospirillum brasilense, Azospirillum lipoferum, Azotobacter chroococcum, Bacillus altitudinis, Bacillus amyloliquefaciens, Bacillus cereus, Bacillus circulans, Bacillus circulanscan, Bacillus coagulans, Bacillus edaphicus, Bacillus firmus, Bacillus flexus, Bacillus globisporus, Bacillus horikoshii, Bacillus licheniformis, Bacillus megaterium, Bacillus methylotrophicus, Bacillus mojavensis, Bacillus mucilaginosus, Bacillus mycoides, Bacillus pasteurii, Bacillus pseudomycoides, Bacillus subtilis, Bacillus thuringiensis, Burkholderia cepacia, Burkholderia glathei, Burkholderia mallei, Burkholderia metallica, Burkholderia pyrrocinia, Burkholderia pyrrocinia, Burkholderia ubonensis, Buttiauxella izardii, Citrobacter Freundii, Clostridium botulinum, Clostridium pasteurianum, Delftia acidovorans, Ensifer adhaerens, Enterobacter aerogenes, Enterobacter asburiae, Enterobacter cancerogenus, Enterobacter cloacae, Enterobacter hormaechei, Erwinia amylovora, Escherichia freundii, Exiguobacterium antarcticum, Flavobacterium johnsoniae, Frateuria aurantia, Fusarium mosseae, Fusarium oxysporium, Fusarium solani, Glomus coronatum, Glomus diaphanum, Glomus etunicatum, Glomus intraradices, Glomus mosseae, Glomus viscosum, Klebsiella variicola, Kocuria rhizophila, Leclercia adecarboxylata, Macrophomina phaseolina, Methylobacterium mesophilicum, Methylobacterium nodulans, Microbacterium foliorum, Microbacterium hominis, Microbacterium testaceum, Myroides odoratimimus, Paenibacillus anaericanus, Paenibacillus glucanolyticus, Paenibacillus kribensis, Paenibacillus mucilaginosus, Pantoea agglomerans, Pantoea ananatis, Penicillium frequentans, Pseudomonas aeruginosa, Pseudomonas azotoformans, Pseudomonas brassicacearum, Pseudomonas chlororaphis, Pseudomonas fluorescens, Pseudomonas korensis, Pseudomonas oryzihabitans, Pseudomonas pseudoalcaligenes, Pseudomonas putida, Pseudomonas taiwanensis, Pseudomonas trivalis, Pseudomonas vancoverencis, Pusillimonas agarexedens, Pusillimonas alkaliterrae, Pusillimonas glucanolyticus, Pusillimonas harena, Rahnella aquatilis, Ralstonia pickettii, Rhizobium leguminosarum, Rhizobium pusense, Rhizoctonia solani, Rizophagus intraradices, Salmonella bongori, Schizophyllum commune, Sclerotinia sclerotiorum, Serratia marcescens, Stenotrophomonas maltophilia, Thiobacillus denitrificans, Trichoderma harzianum, and combinations thereof. In more preferred embodiments of the invention the potassium solubilizing microorganism is selected from the group consisting of Pseudomonas vancoverencis, Pseudomonas korensis, Pseudomonas putida, Pantoea agglomerans, Bacillus amyloliquefaciens, Bacillus licheniformis, Bacillus subtilis, Bacillus mucilaginosus, Frateuria aurantia, and combinations thereof. In the most preferred embodiments of the invention the potassium solubilizing microorganism comprises or is Bacillus mucilaginosus.

It is explicitly envisaged that the potassium solubilizing microorganism may be provided in the form of two or more different species of potassium solubilizing microorganisms as described herein, for example a combination of Pseudomonas vancoverencis, Pseudomonas korensis.

The fertilizer of the invention typically comprises at least 1×10¹ CFU/g (by total weight of the fertilizer), more preferably at least 1×10² CFU/g, most preferably at least 1×10³ CFU/g of the potassium solubilizing microorganism. The invention is not particularly limited with respect to the upper limit of the amount of potassium solubilizing microorganism comprised in the fertilizer. For cost-efficiency reasons, the amount will typically be within the range of 1×10¹ to 1×10⁹ CFU/g (by total weight of the fertilizer), preferably within the range of 1×10² to 1×10⁸ CFU/g, most preferably within the range of 1×10³ CFU/g to 1×10⁷ CFU/g.

As shown in the appended examples, the present inventors have surprisingly shown that the potassium mobilizing microorganisms can survive in the fertilizer of the invention even upon prolonged storage. Hence, in preferred embodiments of the invention, the fertilizer as described herein is storage stable. Storage stable preferably means that the fertilizer complies with CFU₃₀>0.01*CFU₀ wherein CFU₀ is the number of viable microorganisms expressed as CFU/g (by total weight of the fertilizer) provided in the fertilizer at time of its formulation (day 0), and CFU₃₀ is the number of viable microorganisms expressed as CFU/g (by total weight of the fertilizer) determined at day 30, wherein the fertilizer is stored in the dark, in a sealed container at 25° C. Preferably, the fertilizer complies with CFU₃₀>0.1*CFU₀, more preferably the fertilizer complies with CFU₃₀>0.5*CFU₀. In other words, the CFU/g (by total weight of fertilizer) determined after thirty days of storage is more than 1% of the CFU/g at day zero, preferably more than 10%, more preferably more than 50%.

In preferred embodiments of the invention the liquid fertilizer is provided in the form of a solution. The liquid fertilizer preferably has less than 2 wt. % (by total weight of the fertilizer), preferably less than 0.5 wt. %, more preferably less than 0.1 wt. % suspended solids. For the purpose of the present disclosure, the amount of suspended solids is determined based on the amount of particles with a particle size above 2 micron, which can easily be determined by the person skilled in the art by filtering particles with a size above 2 micron from an aliquot of fertilizer and determining their weight. Alternatively, the amount of suspended solids can be calculated based on the amount of insoluble material employed in the fertilizer formulation.

In highly preferred embodiments of the invention, the liquid fertilizer has a pH within the range of 2-4.4, preferably within the range of 2.2-3.4. It was found that, despite the low pH, these fertilizers are storage stable. Potassium solubilizing microorganisms which are particularly preferred for the liquid fertilizers according to the invention are from the genus Bacillus, in particular Bacillus mucilaginosus, Bacillus amyloliquefaciens and Bacillus subtilis. As shown in the appended examples, the present inventors have demonstrated the exceptional stability of these microorganisms in the liquid fertilizers of the present invention. Surprisingly, despite the acidic pH, stable compositions according to the invention could be provided. This is advantageous since this allows the typical “fertilizer grade” potassium sulfate obtained from a Mannheim process to be used. Mannheim-produced potassium sulfate contains, next to the potassium sulfate, minor amounts of acidic impurities which cause a low pH upon dissolution. Such a potassium sulfate is available from Tessenderlo Kerley under the name SoluPotasse®, which has a pH of a 1 wt. % solution of about 2.9. Hence, in some embodiments of the invention the fertilizer is provided wherein the first source of potassium is Mannheim-produced potassium sulfate (K₂SO₄). In some embodiments of the invention the fertilizer is provided wherein the first source of potassium is Mannheim-produced potassium sulfate (K₂SO₄), and wherein the pH of the fertilizer is within the range of 2-4.4, preferably within the range of 2.2-3.4, and wherein the potassium solubilizing microorganism is preferably selected from the genus Bacillus, in particular Bacillus mucilaginosus, Bacillus amyloliquefaciens, Bacillus subtilis, and combinations thereof.

In some embodiments there is provided the fertilizer of the present invention wherein:
the first source of potassium is selected from the group consisting of potassium sulfate (K₂SO₄), potassium bisulfate (KHSO₄), potassium thiosulfate (K₂S₂O₃), dipotassium sulfite (K₂SO₃) potassium bisulfite (KHSO₃), potassium chloride (KCl), potassium magnesium sulfate (K₂SO₄·2MgSO₄), potassium nitrate (KNO₃), potassium sodium nitrate KNa(NO₃)₂, potassium hydroxide (KOH), potassium carbonate (K₂CO₃KHCO₃), potassium orthophosphate KH₂PO₄K₂HPO₄, potassium polyphosphate (K₄P₂O₇), potassium metaphosphate (KPO₃), polyhalite (K₂Ca₂Mg(SO₄)₄·2H₂O), langbeinite (K₂Mg₂(SO₄)₃), kainite (KMg(SO₄)·Cl·3H₂O), picromerite (K₂SO₄·MgSO₄·6H₂O), leonite (K₂SO₄·MgSO₄·4H₂O), aphthitalite (K₃Na(SO₄)₂), K-feldspar minerals, feldspathoid minerals, K-bearing phyllosilicates and combinations thereof, preferably the first source of potassium consists of potassium sulfate (K₂SO₄) and potassium bisulfate (KHSO₄) and the ratio (w/w) of total potassium sulfate to total potassium bisulfate in the fertilizer is within the range of 10:1-200:1;
the fertilizer comprises more than 80 wt. % (by dry weight of the fertilizer) of the first source of potassium, preferably more than 90 wt. %, more preferably more than 92 wt. %; and
preferably the pH of the fertilizer is within the range of 2-4.4, preferably within the range of 2.2-3.4.

The fertilizer of the present invention may optionally comprise further ingredients next to the first source of potassium and the potassium solubilizing microorganism, such as (but not limited to) other fertilizing ingredients, other microorganisms (e.g. plant growth promoting microorganisms), surface active compounds, pH adjusting agents (strong or weak acids or bases), biostimulants (e.g. amino acids or peptides), carriers (e.g. silicates, clays, sugars) etc.

Examples of other fertilizing ingredients such as may be included in the fertilizer of the present invention include a source of macronutrients selected from N, P, S, Ca, or Mg and/or a source of micronutrients selected from Fe, B, Mn, Zn, Cu, Mo, Ni, V, Co.

In specific embodiments of the invention, the fertilizer comprises more than 80 wt. % (by dry weight of the fertilizer) of the first source of potassium, preferably more than 90 wt. %, more preferably more than 92 wt. %. As will be understood by the skilled person, when reference is made throughout this document to the amount of the first source of potassium, this refers to the amount of the compound inclusive of its counterion unless specified otherwise. For example, if the first source of potassium is potassium sulfate and the fertilizer comprises 5 g potassium sulfate and 94 g water per 100 g of fertilizer, then the fertilizer comprises 5 wt. % (by total weight of the fertilizer) of the first source of potassium and 83.3 wt. % (by dry weight of fertilizer) of the first source of potassium.

In some embodiments of the invention, the fertilizer consists essentially of the first source of potassium, the potassium solubilizing microorganism, and water.

In another aspect, the present invention provides a method for the preparation of a fertilizer as described herein comprising the steps of:
a) providing a first source of potassium as described herein;
b) providing a potassium solubilizing microorganism as described herein; and
c) combining the first source of potassium of step (a) and the potassium solubilizing microorganism of step (b) with water.

As will be understood by the skilled person, all embodiments described herein for the fertilizer of the invention, for example relating to the identity and concentrations of the different components, or the stability of the resulting product are equally applicable to the method for the preparation of the fertilizer.

In preferred embodiments of the invention, the first source of potassium of step (a) is provided in the form of a particulate solid. The type of particles is not particularly limited and can be, for example, a powder, granule, prill, pellet or pastille.

In preferred embodiments of the invention, the first source of potassium of step (a) is provided in the form of a powder, preferably a powder having a particle size distribution wherein >80 wt. % of the powder passes through a sieve with a 1.65 mm aperture, preferably >75 wt. % passes through a sieve with 0.3 mm aperture. This particle distribution is useful as it dissolves fast, in particular in case the first source of potassium comprises or consists of potassium sulfate. The powder preferably has a solubility of more than 100 g/l demineralized water (25° C.).

The first source of potassium of step (a) and the potassium solubilizing microorganism of step (b) may be provided in the form of separate compositions. However, in accordance with preferred embodiments of the invention, the first source of potassium of step (a) and the potassium solubilizing microorganism of step (b) are provided in the form of a single composition, which may be liquid or solid.

In some embodiments of the invention, the first source of potassium of step (a) and the potassium solubilizing microorganism of step (b) are provided in the form of a single composition, which is a liquid concentrate comprising the first source of potassium in an amount providing more than 5 wt. % (by total weight of the concentrate) potassium (as K₂O), preferably more than 10 wt. %, more preferably more than 20 wt. %.

In highly preferred embodiments of the invention the first source of potassium of step (a) and the potassium solubilizing microorganism of step (b) are provided in the form of a single composition which is a particulate solid, such as a powder, granule, prill, pellet or pastille. The particulate solid may simply be a dry blend of the first source of potassium and the potassium solubilizing microorganism. However, in accordance with preferred embodiments of the invention, the first source of potassium of step (a) and the potassium solubilizing microorganism of step (b) are provided in the form of a single composition which is a particulate solid wherein the first source of potassium and the potassium solubilizing microorganism are comprised in the same particle (as opposed to e.g. a simple dry blend of inoculum and a potassium source). The invention is not particularly limited with regard to the location of the potassium solubilizing microorganism with respect to the other ingredients of the fertilizer within a particle. Hence, the particle comprising the first source of potassium and the potassium solubilizing microorganism can be any type of agglomerate (e.g. an optionally coated granule, pellet, prill, pastille, etc.) or coated powder. The present inventors have found that embodiments of the method of the invention wherein the first source of potassium of step (a) and the potassium solubilizing microorganism of step (b) are provided in the form of a single composition which is a particulate solid, and wherein the potassium solubilizing microorganism is coated on the outside of the particles are preferable since such coated particles are conveniently and easily obtainable by spraying an aqueous solution of microorganism on particles comprising or consisting of the first source of potassium. Alternatively the potassium solubilizing microorganism may be present in the core of an optionally multi-layered core-shell type particle, or as an intermediate layer of a multi-layered particle, or homogenously distributed throughout the particle.

In some preferred embodiments, step (a) comprises providing a Mannheim-produced potassium sulfate (K₂SO₄), preferably a Mannheim-produced potassium sulfate (K₂SO₄), which has a pH of a 1 wt. % solution in water within the range of 2-4.4, preferably within the range of 2.2-3.4. Such a product is available from Tessenderlo Kerley under the name SoluPotasse®.

Step (c) of the method may be performed in several substeps, for example by performing a first dilution, followed by a second dilution. For example, the fertilizer of the present invention may be prepared by providing combining the first source of potassium of step (a) and the potassium solubilizing microorganism of step (b) with a first amount of water, and injecting the resulting composition into a fertigation system where it is diluted with a second amount of water to a potassium concentration within the range described herein elsewhere.

In another aspect, the present invention provides a method of fertilization comprising simultaneously applying the fertilizer of the present invention to soil and/or foliage, preferably to soil.

As will be understood by the skilled person, all embodiments described herein for the fertilizer of the invention, for example relating to the identity and concentrations of the different components, or the stability of the resulting product are equally applicable to the method of fertilization.

The application can take place at any time before, during or after the growing season. In case of annual crops it is preferred that the application takes place within 4 weeks prior to planting, such as about 2 weeks prior to planting.

The application can take place using any application method suitable for liquid fertilizers, such as spray application, banding, soil injection or fertigation. An advantage of the fertilizer of the present invention is that it is suitable for direct application without needing further dilution or other manipulations. Advantageously, in view of its surprising storage stability, the fertilizers of the present invention can be prepared at a specialized facility, or in the field and stored for several days.

The method of fertilization preferably comprises application of the first source of potassium in an amount within the range of 10-2000 kg potassium (as K₂O) per hectare. The actual dose required depends on local growing conditions including, but not limited to soil type, soil potassium content, crop variety, target yield, etc. For example, mango typically requires about 10-100 kg potassium (as K₂O) per hectare while banana typically requires about 1300-1500 kg potassium (as K₂O) per hectare. It is within the routine capabilities of the skilled person to optimize the actual amount of potassium applied.

In some preferred embodiments, there is provided the method of fertilization wherein the method is for improving the morphological characteristics, the physiological characteristics and/or the yield of tomato crop. In particular, the method is for improving the morphological characteristics, the physiological characteristics and/or for increasing the yield of tomato crop compared to an identical fertilization scheme wherein no microorganism is applied. In preferred embodiments, the method is for increasing the yield of tomato crop by at least 5% compared to an identical fertilization scheme wherein no microorganism is applied, preferably by at least 7%, more preferably by at least 10%.

In some preferred embodiments, there is provided the method of fertilization wherein the method is for increasing the starch content, the yield, and/or the average tuber size of potato crop. In particular, the method is for increasing the starch content, the yield, and/or the average tuber size of potato crop compared to an identical fertilization scheme wherein no microorganism is applied. In preferred embodiments, the method is for increasing the yield of potato crop by at least 5% compared to an identical fertilization scheme wherein no microorganism is applied, preferably by at least 10%, more preferably by at least 14%.

In another aspect, the present invention provides the use of the fertilizers of the invention:
as fertilizer; and/or
for providing nutrients to plants; and/or
for improving the morphological characteristics, the physiological characteristics and/or the yield of tomato crop, preferably for improving the morphological characteristics, the physiological characteristics and/or the yield of tomato crop compared to an identical fertilization scheme wherein no microorganism is applied; and/or
for increasing the starch content, the yield, and/or the average tuber size of potato crop, preferably for increasing the starch content, the yield, and/or the average tuber size of potato crop compared to an identical fertilization scheme wherein no microorganism is applied; and/or
for increasing the leaf K content, preferably for increasing the leaf K content compared to an identical fertilization scheme wherein no microorganism is applied; and/or
for improving the vitamin C content and/or the lycopene content of a crop, preferably a tomato crop.

In preferred embodiments of the present invention there is provided the use of the fertilizers of the invention for improving the morphological characteristics, preferably of tomato crop, wherein the morphological characteristic is selected from fruit size, fruit weight, leaf area and/or uniformity of color.

In preferred embodiments of the present invention there is provided the use of the fertilizers of the invention for improving the physiological characteristics, preferably of potato or tomato crop, wherein the physiological characteristic is selected from firmness, fruit vitamin C content and/or shelf-life.

In highly preferred embodiments of the present invention there is provided the use of the fertilizers of the invention for improving the vitamin C content and/or the lycopene content of a crop, preferably a tomato crop. The vitamin C content and/or the lycopene content is preferably increased in the fruit of the crop, preferably the tomato crop. The vitamin C content is preferably increased by at least 20% and the lycopene content is preferably increased by at least 50%. The increase is preferably determined compared to an identical fertilization scheme wherein no microorganism is applied. As is shown in the appended examples, the present inventors have found that the concentration of vitamin C and lycopene in tomatoes is significantly increased compared to a control when employing the fertilizer of the invention.

In some embodiments, there is provided the use of the fertilizers of the invention for increasing the yield of tomato crop by at least 5% compared to an identical fertilization scheme wherein no microorganism is applied, preferably by at least 7%, more preferably by at least 10%. In preferred embodiments, the use is for increasing the yield of potato crop by at least 5% compared to an identical fertilization scheme wherein no microorganism is applied, preferably by at least 10%, more preferably by at least 14%.

The use preferably comprises application of the fertilizer of the present invention as is described herein in the context of the method of fertilization.

In another aspect, the present invention provides a kit-of-parts comprising a first source of potassium as described herein; a potassium solubilizing microorganism as described herein; and instructions for combining the first source of potassium and the potassium solubilizing microorganism such that a fertilizer as described herein is obtained.

As will be understood by the skilled person, all embodiments described herein for the fertilizer of the invention, for example relating to the identity and concentrations of the different components, or the stability of the resulting product are equally applicable to the kit-of-parts.

As will have been understood based on the above description, particularly preferred embodiments of the invention are described by the following items.

1. A liquid fertilizer comprising
(i) a first source of potassium in an amount providing 0.01-5 wt. % (by total weight of the fertilizer) potassium (as K₂O);
(ii) a potassium solubilizing microorganism; and
(iii) water.

2. The fertilizer of item 1 wherein the first source of potassium is selected from the group consisting of potassium sulfate (K₂SO₄), potassium bisulfate (KHSO₄), potassium thiosulfate (K₂S₂O₃), dipotassium sulfite (K₂SO₃) potassium bisulfite (KHSO₃), potassium chloride (KCl), potassium magnesium sulfate (K₂SO₄·2MgSO₄), potassium nitrate (KNO₃), potassium sodium nitrate KNa(NO₃)₂, potassium hydroxide (KOH), potassium carbonate (K₂CO₃KHCO₃), potassium orthophosphate KH₂PO₄K₂HPO₄, potassium polyphosphate (K₄P₂O₇), potassium metaphosphate (KPO₃), polyhalite (K₂Ca₂Mg(SO₄)₄·2H₂O), langbeinite (K₂Mg₂(SO₄)₃), kainite (KMg(SO₄)·Cl·3H₂O), picromerite (K₂SO₄·MgSO₄·6H₂O), leonite (K₂SO₄·MgSO₄·4H₂O), aphthitalite (K₃Na(SO₄)₂), K-feldspar minerals, feldspathoid minerals, K-bearing phyllosilicates and combinations thereof.

3. The fertilizer of item 2 wherein the first source of potassium is selected from the group consisting of potassium sulfate (K₂SO₄), potassium bisulfate (KHSO₄), potassium thiosulfate (K₂S₂O₃), potassium magnesium sulfate (K₂SO₄·2MgSO₄), polyhalite (K₂Ca₂Mg(SO₄)₄·2H₂O), langbeinite (K₂Mg₂(SO₄)₃) and combinations thereof, preferably wherein the first source of potassium is potassium sulfate (K₂SO₄).

4. The fertilizer of item 3 wherein the first source of potassium is Mannheim-produced potassium sulfate (K₂SO₄).

5. The fertilizer of any one of the previous items wherein the fertilizer comprises more than 80 wt. % (by dry weight of the fertilizer) of the first source of potassium, preferably more than 90 wt. %, more preferably more than 92 wt. %.

6. The fertilizer of any one of the previous items wherein the potassium solubilizing microorganism is selected from the genera Achromobacter, Acidithiobacillus, Alcaligenes, Agrobacterium, Aminobacter, Arthrobacter, Aspergillus, Azospirillum, Azotobacter, Bacillus, Bradyrhizobium, Brevibacillus, Brevundimonas, Burkholderia, Buttiauxella, Chryseobacterium, Citrobacter, Cladosporium, Clostridium, Colletotrichum, Delftia, Enterobacter, Ensifer, Erwinia, Escherichia, Exiguobacterium, Glomus, Frateuria, Flavobacterium, Flectobacillus, Fusarium, Janthinobacterium, Klebsiella, Kluyvera, Kocuria, Lactobacillus, Leclercia, Macrophomina, Mesorhizobium, Methylobacterium, Microbacterium, Myroides, Paenibacillus, Pantoea, Penicillium, Pseudomonas, Pusillimonas, Rahnella, Ralstonia, Rhizobium, Rhizoctonia, Salmonella, Sclerotinia, Schizophyllum, Serratia, Sphingobacterium, Sphingomonas, Stenotrophomonas, Staphylococcus, Thiobacillus, Trichoderma, and combinations thereof, preferably the potassium solubilizing microorganism is selected from the genera Bacillus, Frauteria, Pseudomonas, and combinations thereof.

7. The fertilizer of any one of the previous items wherein the fertilizer complies with CFU₃₀>0.01*CFU₀, preferably, the fertilizer complies with CFU₃₀>0.1*CFU₀, more preferably the fertilizer complies with CFU₃₀>0.5*CFU₀, wherein CFU₀ is the number of viable microorganisms expressed as CFU/g (by total weight of the fertilizer) provided to the fertilizer at time of its formulation (day 0), and CFU₃₀ is the number of viable microorganisms expressed as CFU/g (by total weight of the fertilizer) determined at day 30, wherein the fertilizer is stored in the dark, in a sealed container at 25° C.

8. The fertilizer of any one of the previous items wherein the fertilizer has a pH within the range of 2-4.4, preferably within the range of 2.2-3.4 and the potassium solubilizing microorganisms is selected from the genus Bacillus.

9. The fertilizer of any one of the previous items wherein the potassium solubilizing microorganism is selected from the group consisting of Bacillus mucilaginosus, Bacillus amyloliquefaciens, Bacillus subtilis and combinations thereof.

10. The fertilizer of any one of the previous items wherein the fertilizer further comprises a source of macronutrients selected from N, P, S, Ca, or Mg and/or a source of micronutrients selected from Fe, B, Mn, Zn, Cu, Mo, Ni, V, Co.

11. The fertilizer of any one of the previous items wherein the fertilizer is provided in the form of a solution having less than 2 wt. % (by total weight of the fertilizer), preferably less than 0.5 wt. %, more preferably less than 0.1 wt. % suspended solids.

12. A method of fertilization comprising applying the fertilizer of any one of items 1-11 to soil and/or foliage, preferably soil.

13. The use of the fertilizer of any one of items 1-12:
as fertilizer; and/or
for providing nutrients to plants; and/or
for improving the morphological characteristics, the physiological characteristics and/or the yield of tomato crop, preferably for improving the morphological characteristics, the physiological characteristics and/or the yield of tomato crop compared to an identical fertilization scheme wherein no microorganism is applied; and/or
for increasing the starch content, the yield, and/or the average tuber size of potato crop, preferably for increasing the starch content, the yield, and/or the average tuber size of potato crop compared to an identical fertilization scheme wherein no microorganism is applied; and/or
for increasing the leaf K content, preferably for increasing the leaf K content compared to an identical fertilization scheme wherein no microorganism is applied; and/or
for improving the vitamin C content and/or the lycopene content of a crop, preferably a tomato crop.

14. A method for the preparation of a fertilizer as described herein comprising the steps of:
a) providing a first source of potassium as described in items 1-4;
b) providing a potassium solubilizing microorganism; and
c) combining the first source of potassium of step (a) and the potassium solubilizing microorganism of step (b) with water.

15. The method of item 14 the first source of potassium of step (a) and the potassium solubilizing microorganism of step (b) are provided in the form of a powder having a particle size distribution wherein >80 wt. % of the powder passes through a sieve with a 1.65 mm aperture, preferably >75 wt. % passes through a sieve with 0.3 mm aperture, and wherein the first source of potassium and the potassium solubilizing microorganism are comprised in the same particle.

### EXAMPLES

### Example 1: Field Trial on Tomato

The effect of simultaneous fertilization of a potassium source and potassium solubilizing microorganisms on tomato was investigated.

A potassium sulfate (brand name SoluPotasse®) obtained from Tessenderlo Kerley was simultaneously applied with Pseudomonas vancoverencis and Pseudomonas korensis. The potassium sulfate had the following characteristics (before blending):

| | |
|---|---|
| Appearance | fine white powder |
| bulk density (struck/loose) | 1.46 kg/l/1.21 kg/l |
| angle of repose | 40° |
| sieve analysis | 20 wt. % > 0.300 mm, 60-70 wt. % > |
| | 0.125 mm, 30-40% < 0.125 mm |
| pH (1 wt. % solution) | 2.0 |
| residues | 0.03% |
| solubility at 25° C. | 120 g/l demineralized water |
| dissolved after 3 mins | 90% |
| with stirring | |
| potassium content as K₂O | 51.5 wt. % |
| chloride content | 0.6 wt. % |
| sulfur content as SO₃ | 47 wt. % |
| water content | 0.02 wt. % |

Tomato (Var. Hirad) was planted in sandy loam soil (soil K content=70 ppm) in 15 kg pots in a greenhouse and drip irrigation applied under normal watering conditions. Potassium sulfate and an inoculum powder of Pseudomonas vancoverencis and Pseudomonas korensis were simultaneously applied to the soil at a rate of 126 kg and 300 g per hectare respectively in 3 split applications during flowering, fruit set and fruit development (plus all fertilizers received by control). The control consisted of regular NP fertilizer (15:5) and micro fertilizer applied daily until the end of harvest, as well as potassium sulfate (SoluPotasse®) fertilizer applied once a week at total rate of 600 kg/ha (which was partially substituted for 126 kg Potassium sulfate applied simultaneously with microorganism for three applications of the test pots). The resulting tomatoes were evaluated for morphological traits and physiological traits according to the principal component analysis and factor analysis using STATISTICA 8.0 software.

The results are shown in the below table

| | | Leaf K content | Fruit | Fruit |
|---|---|---|---|---|
| | Yield | (mg/g dry | Vitamin C | Lycopene |
| | (T/ha) | weight) | (mg/100 gr) | (mg/kg) |
| Control | 48.78 | 36.9 | 19.1 | 19.5 |
| Fertilizer according | 58.7 | 77.97 | 24.2 | 33.2 |
| to the invention | | | | |

Simultaneous application of a potassium source and potassium solubilizing microorganisms resulted in significant increases in morphological parameters (such as firmness and even ripening), physiological parameters (such as leaf K content, fruit Vitamin C content, fruit Lycopene content) and yield of the tomatoes compared to the control treatment employing a corresponding fertilization scheme without potassium solubilizing bacteria.

### Example 2: Survival of Potassium Solubilizing Bacteria in Liquid Potassium Sulfate Fertilizers

Pure potassium sulfate powder (brand name SoluPotasse®) obtained from Tessenderlo Kerley and having the characteristics described in example 1 was dry blended with potassium solubilizing microorganism at a concentration of 1×10⁷ CFU per 100 g fertilizer, 5×10⁷ CFU per 100 g fertilizer, 1×10⁸ CFU per 100 g fertilizer and 2×10⁸ CFU per 100 g fertilizer. A 10% solution (in demi water) of the mixtures was prepared and stored at room temperature in the shade in a closed vessel. A sample of the solution was taken every day for a month, and plated onto a sterile NB (Nutrient Broth) growth medium in a Petri dish, which was incubated (24-48 hour) and submitted to a colony count in order to assess the survival of the tested microorganisms in the potassium sulfate solution.

The following potassium solubilizing microorganisms were tested: Pseudomonas korensis, Pseudomonas vancoverencis, Pseudomonas putida, Pantoea agglomerans, and Bacillus subtilis.

It was found that the number of viable colonies in the Bacillus subtilis samples remained stable up until at least a month, while the number of viable colonies was already decreased significantly after 24 hours for the other microorganisms. Hence, if the fertilizer of the present invention is intended to be dissolved and applied as a liquid (e.g. via spray, injection or fertigation application), it is preferably used immediately after dissolution. However, it was demonstrated that when microorganisms from the genus Bacillus are used, such as Bacillus subtilis, the shelf-life in dissolved solution remained stable. This is an important practical advantage since in practice the dissolved fertilizer may be stored in tanks for a number of days, e.g. during prolonged fertigation application.

### Example 3: Open Field Trial on Potato (1)

The effect of simultaneous application of a potassium source and potassium solubilizing microorganisms on potato variety Taros was investigated on a 2000 m² plot divided into a control and test plot with a soil potassium content of 500 ppm. Granular potassium sulfate (brand name GranuPotasse®) obtained from Tessenderlo Kerley and having the characteristics described in the following table was dry blended with 1×10⁷ CFU per 100 g fertilizer of a blend of Pseudomonas vancoverencis and Pseudomonas korensis.

| | |
|---|---|
| Appearance | light grey to beige granules |
| bulk density (struck/loose) | 1.40 kg/l/1.27 kg/l |
| angle of repose | 33° |
| Sieve analysis | 97% between 1.6 |
| | mm and 5 mm |
| potassium content as K₂O | 50.2 wt. % |
| chloride content | 2.3 wt. % |
| sulfur content as SO₃ | 45 wt. % |
| water content | 0.2 wt. % |

A control plot was treated according to regular local practices including pre-planting fertilization, fertilization during the growing season, and weed control. The GranuPotasse® was applied at a rate of 250 kg/ha two weeks prior to planting.

A test plot was treated identical to the control, however instead of GranuPotasse®, the granular potassium sulfate and microorganism blend was applied at the same potassium rate.

The results are shown in the following table.

| | Total | Marketable |
|---|---|---|
| | yield | yield (t/ha) |
| | (t/ha) | (35-55 mm tubers) |
| Control | 59.13 | 54.63 |
| Test plot | 70.86 | 66.44 |

Simultaneous application of a potassium source and potassium solubilizing microorganisms resulted in significant increases in yield, marketable yield, starch content, and leaf potassium content of the potatoes compared to a control treatment employing a corresponding fertilization scheme without potassium solubilizing bacteria.

### Example 4: Open Field Trial on Potato (2)

The effect of simultaneous application of a potassium source and potassium solubilizing microorganisms on the starch content and leaf potassium content of potato variety Banba was investigated on a 2500 m² plot divided into a control and test plot with a soil potassium content of 275 ppm.

Granular Potassium sulfate (brand name GranuPotasse®) obtained from Tessenderlo Kerley and having the characteristics described in example 3 was dry blended with 1×10⁷ CFU per 100 g fertilizer of a blend of Pseudomonas vancoverencis and Pseudomonas korensis.

A control plot was treated according to regular local practices including pre-planting fertilization, fertilization during the growing season, and weed control. The GranuPotasse® was applied at a rate of 250 kg/ha (according to farmer practices) two weeks prior to planting. Tuber planting was done in June 2020 and the irrigation was performed between 4-8 day intervals, depending on the summer time temperature. Leaf analysis was done by obtaining approximately 500 g leaves (mid-size) of the plants which was immediately sent to laboratory for leaf analysis.

A test plot was treated identical to the control, however instead of GranuPotasse®, the granular potassium sulfate and microorganism blend was applied at the same potassium rate.

The results are shown in the following table.

| | Leaf K (wt. % | Starch (wt. % |
|---|---|---|
| | dry matter) | dry matter) |
| Control (Banba) | 3.88 | 8.05 |
| Test plot (Banba) | 4.25 | 11.01 |

Simultaneous application of a potassium source and potassium solubilizing microorganisms resulted in significant increases in starch content and leaf potassium content of the potatoes compared to a control treatment employing a corresponding fertilization scheme without potassium solubilizing bacteria.

### Example 5: Survival of Potassium Solubilizing Bacteria in Combination with Various Potassium Fertilizers

In order to evaluate the stability of the fertilizers of the present invention and of precursors to prepare, the following fertilizers 1-4 were prepared. The fertilizers 1-4 were stored at room temperature in the shade in a closed vessel that was opened periodically to sample the fertilizer to assess the survival of the tested microorganisms in the potassium fertilizer.

Every week for a month, then every month a sample (after dissolution for solid samples) was plated onto a sterile NB (Nutrient Broth) growth medium in a Petri dish, which was incubated (24-48 hour) and submitted to a colony count in order to assess the survival of the tested microorganisms in the potassium sulfate solution. The results are shown in the below table.

| | | Potassium | | CFU/100 g | CFU/100 g | CFU/100 g |
|---|---|---|---|---|---|---|
| | Potassium | solubilizing | Preparation | fertilizer | fertilizer | fertilizer |
| Fertilizer | fertilizer | bacterium | method | Day 21 | Day 110 | Day 210 |
| 1 (solid) | SoluPotasse ® | Bacillus | dry blend | 1 × 10⁸ | 6 × 10⁷ | Not tested |
| | | subtilis | | | | |
| 2 (liquid) | KTS ® | Bacillus | dissolved into | 2 × 10⁸ | 9 × 10⁷ | Not tested |
| | | subtilis | pure KTS ® | | | |
| 3 (solid) | SoluPotasse ® | Bacillus | dry blend | 9 × 10⁷ | 8 × 10⁷ | 8 × 10⁷ |
| | | mucilaginous | | | | |
| 4 (Liquid) | KTS ® | Bacillus | dissolved into | 9 × 10⁷ | 6 × 10⁷ | 7 × 10⁷ |
| | | mucilaginous | pure KTS ® | | | |

The GranuPotasse® had the characteristics (before coating) described in example 3, the SoluPotasse® had the characteristics (before coating) described in example 1. The KTS® is a solution of potassium thiosulfate in water which had the following characteristics (before blending):

| Appearance | clear and colorless | |
|---|---|---|
| density (25° C.) | 1.47 | kg/l |
| Salt Out Temperature | −10° | C. |
| potassium content as K₂O | 36.8% (w/v) = | |
| | 25.03 wt. % | |
| sulfur content as SO₃ | 62.4% (w/v) | |
| water content | 0.2 | wt. % |

It was found that the fertilizers according to the invention and precursors which can be used to make the fertilizers according to the invention demonstrate excellent stability.

1. A liquid fertilizer comprising
(i) a first source of potassium in an amount providing 0.01-5 wt. % (by total weight of the fertilizer) potassium (as K₂O);
(ii) a potassium solubilizing microorganism; and
(iii) water;
wherein the first source of potassium is selected from the group consisting of potassium sulfate (K₂SO₄), potassium bisulfate (KHSO₄), potassium thiosulfate (K₂S₂O₃), dipotassium sulfite (K₂SO₃) potassium bisulfite (KHSO₃), potassium chloride (KCl), potassium magnesium sulfate (K₂SO₄·2MgSO₄), potassium nitrate (KNO₃), potassium sodium nitrate KNa(NO₃)₂, potassium hydroxide (KOH), potassium carbonate (K₂CO₃KHCO₃), potassium orthophosphate KH₂PO₄K₂HPO₄, potassium polyphosphate (K₄P₂O₇), potassium metaphosphate (KPO₃), polyhalite (K₂Ca₂Mg(SO₄)₄·2H₂O), langbeinite (K₂Mg₂(SO₄)₃), kainite (KMg(SO₄)·Cl·3H₂O), picromerite (K₂SO₄·MgSO₄·6H₂O), leonite (K₂SO₄·MgSO₄·4H₂O), aphthitalite (K₃Na(SO₄)₂), K-feldspar minerals, feldspathoid minerals, K-bearing phyllosilicates and combinations thereof, and
wherein the fertilizer comprises more than 80 wt. % (by dry weight of the fertilizer) of the first source of potassium.

2. The fertilizer of claim 1 wherein the first source of potassium is selected from the group consisting of potassium sulfate (K₂SO₄), potassium bisulfate (KHSO₄), potassium thiosulfate (K₂S₂O₃), potassium magnesium sulfate (K₂SO₄·2MgSO₄), polyhalite (K₂Ca₂Mg(SO₄)₄·2H₂O), langbeinite (K₂Mg₂(SO₄)₃) and combinations thereof.

3. The fertilizer of any one of claim 1, wherein the first source of potassium is Mannheim-produced potassium sulfate (K₂SO₄).

4. The fertilizer of claim 1, wherein the fertilizer comprises less than 2 wt. % (by total weight of the fertilizer), of carboxylic acid salts of potassium.

5. The fertilizer of claim 1, wherein the total amount of potassium (as K₂O) in the fertilizer is less than 15 wt. % (by total weight of the fertilizer).

6. The fertilizer of claim 1, wherein the potassium solubilizing microorganism is selected from the genera Achromobacter, Acidithiobacillus, Alcaligenes, Agrobacterium, Aminobacter, Arthrobacter, Aspergillus, Azospirillum, Azotobacter, Bacillus, Bradyrhizobium, Brevibacillus, Brevundimonas, Burkholderia, Buttiauxella, Chryseobacterium, Citrobacter, Cladosporium, Clostridium, Colletotrichum, Delftia, Enterobacter, Ensifer, Erwinia, Escherichia, Exiguobacterium, Glomus, Frateuria, Flavobacterium, Flectobacillus, Fusarium, Janthinobacterium, Klebsiella, Kluyvera, Kocuria, Lactobacillus, Leclercia, Macrophomina, Mesorhizobium, Methylobacterium, Microbacterium, Myroides, Paenibacillus, Pantoea, Penicillium, Pseudomonas, Pusillimonas, Rahnella, Ralstonia, Rhizobium, Rhizoctonia, Salmonella, Sclerotinia, Schizophyllum, Serratia, Sphingobacterium, Sphingomonas, Stenotrophomonas, Staphylococcus, Thiobacillus, Trichoderma, and combinations thereof.

7. The fertilizer of claim 1, wherein the fertilizer complies with CFU₃₀>0.01*CFU₀, wherein CFU₀ is the number of viable microorganisms expressed as CFU/g (by total weight of the fertilizer) provided to the fertilizer at time of its formulation (day 0), and CFU₃₀ is the number of viable microorganisms expressed as CFU/g (by total weight of the fertilizer) determined at day 30, wherein the fertilizer is stored in the dark, in a sealed container at 25° C.

8. The fertilizer of claim 1, wherein the fertilizer has a pH within the range of 2-4.4, and the potassium solubilizing microorganisms is selected from the genus Bacillus.

9. The fertilizer of claim 1, wherein the potassium solubilizing microorganism is selected from the group consisting of Bacillus mucilaginosus, Bacillus amyloliquefaciens, Bacillus subtilis and combinations thereof.

10. The fertilizer of claim 1, wherein the fertilizer further comprises a source of macronutrients selected from N, P, S, Ca, or Mg and/or a source of micronutrients selected from Fe, B, Mn, Zn, Cu, Mo, Ni, V, Co.

11. The fertilizer of claim 1, wherein the fertilizer is provided in the form of a solution having less than 2 wt. % (by total weight of the fertilizer).

12. A method of fertilization comprising applying the fertilizer of claim 1 to soil and/or foliage.

13. (canceled)

14. A method for the preparation of a fertilizer as described herein comprising the steps of:
a) providing a first source of potassium as described claim 1;
b) providing a potassium solubilizing microorganism; and
c) combining the first source of potassium of step (a) and the potassium solubilizing microorganism of step (b) with water.

15. The method of claim 14 the first source of potassium of step (a) and the potassium solubilizing microorganism of step (b) are provided in the form of a powder having a particle size distribution wherein >80 wt. % of the powder passes through a sieve with a 1.65 mm aperture, preferably >75 wt. % passes through a sieve with 0.3 mm aperture, and wherein the first source of potassium and the potassium solubilizing microorganism are comprised in the same particle.
